(19) United States
(12) Patent Application Publication
(10) Pub. No.: US 2013/0167879 A1
(43) Pub. Date: Jul. 4, 2013

(54) Methods and systems for cleaning for cyclic nucleation transport (CNX)

(71) Applicant: Richard W. Plavidal, Fremont, CA (US)

(72) Inventor: Richard W. Plavidal, Fremont, CA (US)

(73) Assignee: HyperFlo LLC, Tempe, AZ (US)

(21) Appl. No.: 13/733,122

(22) Filed: Jan. 2, 2013

Related U.S. Application Data
(60) Provisional application No. 61/582,482, filed on Jan. 2, 2012.

(51) Int. Cl. B08B 3/10

(52) U.S. Cl. CPC B08B 3/10
USPC 134/26; 134/42

(57) ABSTRACT

Methods are disclosed to create and employ the use of non-vapor, non-condensable gas bubbles inside a process chamber. These non-vapor gas bubbles may be rapidly expanded and compressed in pressure-controlled cycles and can assist in the transport of fluids, particles, and by-products to and from surfaces. The gas bubbles can be generated from dissolved gas to the liquid medium, by mixing two liquids that can react with each other to generate gaseous by-products, or by using a liquid medium that can react with the surface of the object to generate gaseous by-products. The gaseous generation can be used with cyclic nucleation transport (CNX) process, such as vacuum CNX, hyperbaric CNX, or dynamic CNX.

This application claims priority from provisional patent application Ser. No. 61/582,482, filing date Jan. 2, 2012, entitled “Methods and systems for cleaning”, which is hereby incorporated by reference in its entirety.

### BACKGROUND

Parts or devices with complex shapes pose a special challenge for cleaning due to small openings, internal dead spaces, blind holes and other hard to access places within the part. Traditional sprays and sonic agitation cannot access these areas effectively and even if they could it would be difficult or impossible to remove loosened debris and contaminated cleaning solutions from these parts. Even complex manifold flow connections cannot effectively flush contamination from trapped areas and dead spaces within some parts.

### SUMMARY

In some embodiments, a hyperbaric cyclic nucleation transport (H-CNX) process is disclosed, including pressure cycling liquid and/or vapor from pressure higher than atmospheric pressure or vapor across the boiling point of the liquid. The higher pressure can be accompanied by higher temperature, which provides additional benefits of more efficient cleaning and cheaper liquid medium. The cycling can be performed by varying pressure, for example, from a pressure equal or higher than the boiling pressure of the liquid (and higher than atmospheric pressure in some embodiments) to a pressure lower or equal than the boiling pressure of the liquid (which can be higher or lower than atmospheric pressure). At the pressure lower than the boiling point, the liquid starts to boil, generating bubbles. The process conditions are preferably controlled so that the bubbles are generated at the surface of an object that is at least partially submerged in the liquid. For example, at onset of boiling, bubbles are mostly generated at the surfaces of the object, thus in some embodiments, the pressure reduction is controlled to maintain the onset of boiling condition, avoiding the rigorous boiling regime in which the bubbles are generated within the liquid.

In some embodiments, a dynamic cyclic nucleation transport (D-CNX) process is disclosed, including cyclically changing the volume of a process chamber, for example, through a piston or bellows. A D-CNX process and system can include a dynamic chamber volume that can instantly change from vacuum to pressure conditions and eliminates vacuum pumps. The potential benefits of the D-CNX process can include faster than using vacuum pumps to create pressure differences, no net evaporative cooling loss as a result of vapors being drawn from the solution and through the vacuum pump with every CNX cycle; chemistry mixture remains constant due to the fact that volatile components will be re-condensed with every CNX cycle rather than be removed through the vacuum pump; no vacuum pump is required, along with associated pipes, valves, surge tanks and isolation tanks; potentially flammable vapors (if present) are not concentrated and exposed to atmosphere through vacuum pumps; greater efficiency (<½ the power) due to the ability to recapture potential energy during the re-compression cycle; and continuous recycling and filtering of fluid through the process chamber with each CNX cycle.

In some embodiments, methods are disclosed to create and employ the use of non-vapor, non-condensable gas bubbles inside a process chamber. These non-vapor gas bubbles may be rapidly expanded and compressed in pressure-controlled cycles and can assist in the transport of fluids, particles, and by-products to and from surfaces. The nucleation site for gas or vapor bubbles can prefer discontinuous or contaminated surfaces and can effectively form inside tubes, holes and dead spaces found in complex 3D part structures where conventional sprays, sonic waves, brushes cannot reach. The gas bubbles can be generated from dissolved gas to the liquid medium, by mixing two liquids that can react with each other to generate gaseous by-products, or by using a liquid medium that can react with the surface of the object to generate gaseous by-products. The gaseous generation can be used with cyclic nucleation transport (CNX) process, such as vacuum CNX, hyperbaric CNX, or dynamic CNX.

### BRIEF DESCRIPTION OF THE DRAWINGS

FIG. 1 illustrates different temperature and pressure regimes of CNX processes according to some embodiments.

FIG. 2 illustrates a steam enthalpy-entropy chart for different steam pressures and temperatures.

FIG. 3 illustrates a system for operating hyperbaric CNX according to some embodiments.

FIG. 4 illustrates a flow chart for a hyperbaric CNX process according to some embodiments.

FIG. 5 illustrates a flow chart for a hyperbaric cyclic cleaning and drying process according to some embodiments.

FIGS. 6A-6C illustrate a dynamic chamber using piston according to some embodiments.

FIG. 7 illustrates a flow chart for a dynamic CNX process according to some embodiments.

FIG. 8 illustrates a flow chart for a dynamic CNX process according to some embodiments.

FIG. 9 illustrates a process sequence for an effective displacement according to some embodiments.

FIG. 10 illustrates a flowchart example for a CNX process according to some embodiments.

FIG. 11 illustrates a flowchart example for a CNX process according to some embodiments.

FIG. 12 illustrates a flowchart example for a CNX process according to some embodiments.

### DETAILED DESCRIPTION

The development of Vacuum Cyclic Nucleation Transport (V-CNX) technology represented a breakthrough in addressing the problem of cleaning of objects with complex shapes. With V-CNX it was possible to grow and collapse vapor bubbles in a vacuum environment which would displace fluids and dislodge contamination from hidden surfaces independent of boundary layers and geometries which would otherwise block any cleaning agitation or displacement. A key attribute of V-CNX is that all surfaces see the same pressure in a pressure controlled environment. Therefore, vapor bubbles will be created at any surface, whether hidden from direct view or not. As long as the pressure is held below the fluid vapor pressure, nucleation continues unabated and displacement currents continue to flow. Upon re-pressurization the vapor bubbles collapse and bring both fresh fluid and kinetic energy to the surface. Until now, V-CNX operated in a sub-atmospheric pressure regime, using a vacuum pump to create the vacuum space. In the sub-atmospheric pressure regime, the vapor pressures of common process fluids, such as water, have sub-atmospheric vapor pressure in the normal temperature range. The vacuum pump can generate the necessary environment, e.g., the vacuum space, for the generation of bubbles.

### Hyperbaric Cyclic Nucleation Transport (H-CNX)

In some embodiments, the present invention discloses a hyperbaric cyclic nucleation transport (H-CNX) process, which includes cycling pressure from above atmospheric to above, about or below atmospheric pressure. The pressure can be the vapor phase pressure of a liquid medium. The liquid medium can partially fill a container, leaving a portion of the container for the vapor phase of the liquid medium. The liquid medium can also totally fill the container. The liquid medium can include superheated water, having a vapor pressure above the atmospheric temperature.

In some embodiments, the present invention relates to CNX processes and systems, which includes generating and terminating bubbles. In some embodiments, an object can be disposed in a high-energy liquid medium at high vapor pressure. Low vapor pressure environment can be established to form bubbles, which act to release the energy from the liquid medium. At a low energy release rate, the bubbles can nucleate at the object surface. If the energy is released at a higher rate, the bubbles can form in the liquid medium. The bubbles are then terminated when at the surface, and during the collapse of the bubbles, energy can be provided to the object surface, removing any adhering contamination or residue. The cycling of bubbles, generation and termination, can act to clean the object surface, even at hard to reach places. The energy can be in the forms of pressure, temperature, or chemical active liquid.

In some embodiments, an object is partially or totally submerged in a liquid medium in a sealed container. The liquid can partially or totally fill the container. The liquid medium has a vapor phase pressure above the atmospheric pressure. The liquid medium is not boiling or not at an onset of boiling, meaning there are no bubble formation within the liquid, either at the object surface or at the liquid medium. The pressure within the sealed container is decreased, for example, by opening a relief valve to the atmosphere. Since the liquid medium is at higher vapor pressure, reducing the pressure can lead to bubble formation, e.g., onset of boiling with bubbles nucleated at the object surface. The pressure within the sealed container is then increased, for example, by closing the relief valve and/or by adding energy to the liquid. The energy from the liquid can be released, increasing the vapor pressure. Additional energy can be added to the liquid, for example, constantly or intermittently, e.g., only added to the liquid during the period that the relief valve is closed. The energy can be added when the energy stored in the liquid is low, for example, when the liquid temperature or pressure drops to an equilibrium level. The added energy can be in the form of thermal energy, such as providing additional heated liquid or heated vapor. In addition, the added energy can include heating the liquid, e.g., through a heater disposed inside or outside the container. The bubbles are then terminated due to the high vapor phase pressure. The pressure cycling can be repeated, with the pressure cycles at above atmospheric pressure. The cycling of bubbles, e.g., repeated sequence of bubble formation and termination, can lead to a cleaning of the object surface.

In some embodiments, the pressure can gradually decrease, which can lead to more and more bubbles nucleated at the object surface with minimum bubbles formed within the liquid. The pressure can decrease to a value above atmospheric pressure, above atmospheric pressure, or below atmospheric pressure. Thus the pressure can cycle at two values of pressure wherein both of these values are above atmospheric pressure. Alternatively, the pressure can cycle from an above atmospheric pressure to an about atmospheric pressure. Alternatively, the pressure can cycle from an above atmospheric pressure to a below atmospheric pressure.

In some embodiments, an object is partially or totally submerged in a gaseous medium in a sealed container. The gas can partially or totally fill the container. There can be some liquid in the container, or the container can be filled with gaseous medium. The gas medium has a vapor phase pressure above the atmospheric pressure. The pressure within the sealed container is decreased, for example, by opening a relief valve to the atmosphere. The pressure within the sealed container is then increased, for example, by closing the relief valve and/or by adding energy to the gaseous or liquid medium. After closing the relief valve, the pressure can re-establish its equilibrium, which can still be above atmospheric pressure. The pressure cycling can be repeated, with the pressure dropping lower and lower toward atmospheric pressure. Additional liquid or vapor can be added to the container to increase the energy of the medium in the container. And then the cycle can be repeated. Additional energy can also be added by heating through a heater disposed inside or outside the container.

In some embodiments, the liquid or gaseous medium can be supplied to the container through a reservoir. The reservoir can be heated to maintain a constant supply of liquid and gas at the proper pressure to the container. The cycling of pressure in the container can be through the reservoir, for example, by draining liquid or releasing gas from the container back to the reservoir (or to a waste container), and by supplying new liquid or gas at appropriate pressure to the container.

In some embodiments, by maintaining the liquid at high pressure, the liquid can be brought to a higher temperature without any bubble formation. A cyclic process can be performed at high temperature, e.g., higher than the boiling temperature of the liquid medium. The high temperature can allow the use of inexpensive liquid, such as water, for cleaning instead of the more expensive solvent or cleaning chemicals. The high temperature can also allow drying of the object, since the liquid vapor can be quickly evaporated when returning to atmospheric pressure. The high temperature can also allow sterilization, since microscopic organisms cannot survive high temperature exposure, such as 130 or 160 degrees.

In addition, the present invention can simplify the cleaning equipment, for example, by eliminating the vacuum pump needed to reduce the pressure to below atmospheric pressure. Instead, a relief valve can be used to reduce pressure from a pressure above the atmospheric pressure.

The benefit of utilizing CNX technology to grow and collapse vapor bubbles for cleaning and other surface treatment processes can be abundant. The CNX processes can be operated in sub-atmospheric pressure regimes, as well as at higher than atmospheric pressure regimes. The incorporation of a hyperbaric chamber can permit operating CNX processes at elevated pressure ranges. The high pressure regimes can create significantly greater displacement forces inside complex parts to improve cleaning.

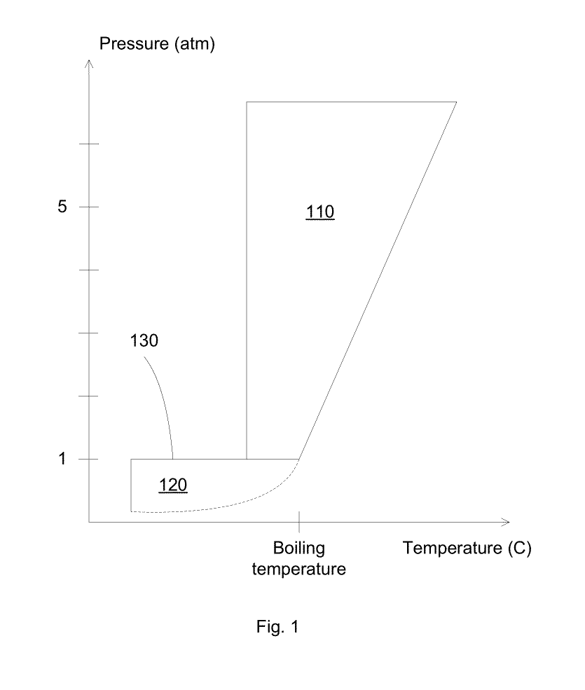

FIG. 1 illustrates different temperature and pressure regimes of CNX processes according to some embodiments. An atmospheric regime 130 can provide a limited temperature range, e.g., below the boiling temperature of the liquid at atmospheric pressure. For example, for water liquid, the temperature range is less than 100 C., which is the boiling temperature of water at atmospheric pressure. Further, in the atmospheric pressure regime, the nucleation of bubbles can require ultrasonic energy, which can have unwanted cavitation.

A sub-atmospheric regime 120 can include pressure below atmospheric pressure and temperature below boiling temperature at atmospheric pressure. The sub-atmospheric pressure regime 120 can also have a limited temperature range, e.g., below the boiling temperature of the liquid at atmospheric pressure. For example, for water liquid, the temperature range is less than 100 C., which is the boiling temperature of water at atmospheric pressure. The sub-atmospheric pressure regime 120 can provide gentle pressure cycles, e.g., the pressure difference is less than 1 atm, with potential recovering and cycling of solvents, together with immediate drying with appropriate solvent mixtures.

A hyperbaric pressure regime 110 can include pressure above atmospheric pressure. The hyperbaric pressure regime 110 can have a higher process temperature range, such as temperatures lower or higher than the boiling temperature of the liquid at atmospheric pressure. Higher temperatures can be associated with faster reaction rates which increases part processing speed and cleaning effectiveness. Greater pressure cycles can be used, e.g., the pressure difference between bubble generation and bubble termination can be higher than 1 atm. Water and steam can be used at elevated temperatures to clean without the use of dangerous, expensive, or environmentally unfriendly chemicals. For example, sterilization may be accomplished in-situ with the cleaning process since autoclave conditions can be achieved as a natural consequence of H-VCN processing. Deionized water at high temperature and pressure can offer superior cleaning and degreasing without solvents

In addition, in this hyperbaric pressure regime 110, immediate object drying can be achieved using water medium without added solvent mixture. For example, a rapid drop in pressure of a superheated steam ambient can evaporate the droplets at the object surfaces, rapidly drying the object. The hyperbaric pressure regime can provide a more efficient drying, which is aided by the elevated temperatures as well as the ability for expanding vapor bubbles to rapidly displace trapped liquid on the surfaces of a part.

Further benefits of the use of H-CNX can include simple design, such as eliminating vacuum pumps since pressure can be released to atmospheric pressure. Faster cycling can also be achieved by the elimination of the vacuum pumps, since the pressure built up and released can be established much quicker than generating a vacuum ambient. The high pressure regime can provide a more powerful bubble nucleation cleaning as compared to sub-atmospheric pressure regime.

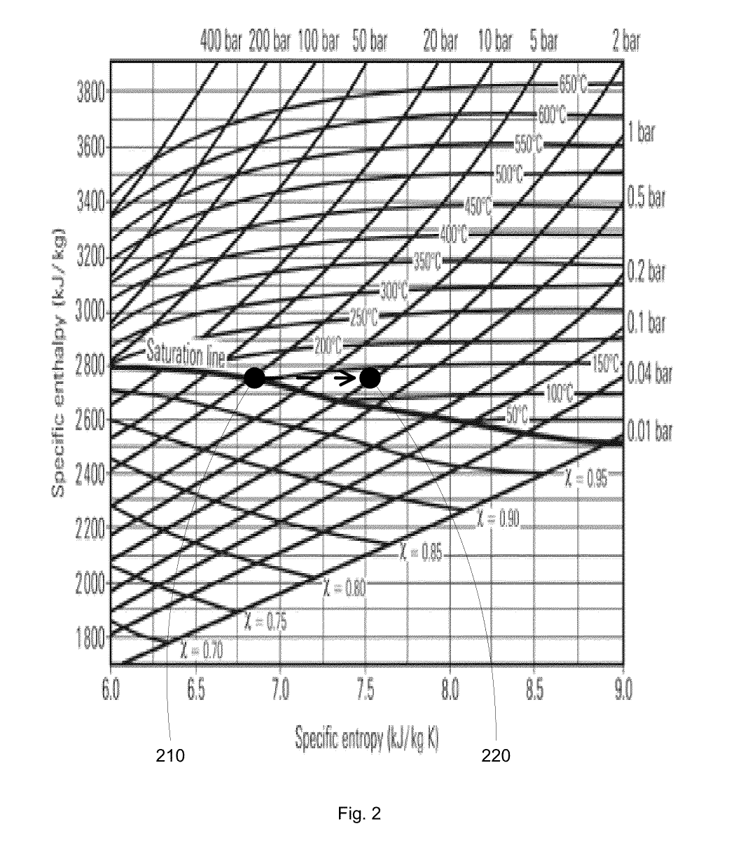

In some embodiments, the present invention utilizes steam (in liquid or gaseous phase) as the medium for cleaning. FIG. 2 illustrates a steam enthalpy-entropy chart for different steam pressures and temperatures. Steam can be cycled between a first saturated steam 210 (e.g., at 5 bar pressure and 160 C. temperature) and a second saturated steam 220 (e.g., at 1 bar and 130 C.). High pressure to low pressure can be achieved by adiabatic expansion, for example, through a relief valve. The outlet of the relief valve can be released to the atmosphere ambient, or can be recycled to a reservoir for re-use. Low pressure to high pressure can be achieved by heating the steam or by introducing new steam at high pressure and high temperature. The pressure and temperature of the newly introduced steam can be higher than the operation point, so that it can mixed with the existing steam in the container and achieve the operation point of pressure and temperature. Liquid can be also drained from the container, and new liquid can be introduced (in addition or in place of the steam) to bring the steam in the container to the operation point. The outlet of the drainage can be released to a waste container, or can be recycled to a reservoir for re-use.

In some embodiments, the present invention discloses systems and processes for hyperbaric CNX. The system can use a controlled process chamber pressure release to nucleate and expand vapor and gas bubbles that have been produced or released at the surface of a part in order to displace and expel process fluids, reaction byproducts, and/or unwanted debris and contamination from the surface of the part. The process chamber can be re-pressurized after the pressure release and nucleation step to collapse vapor bubbles and flush the part with fresh process fluid as well as introduce energy from the collapse to enhance surface reactions and displace reaction byproducts and/or unwanted debris and contamination from the surface of the part. A heated and pressurized process fluid supply reservoir can be used to deliver either hot liquid under controlled pressure to the process chamber or hot vapor or steam under controlled pressure to the process chamber. The system can include a hyperbaric process chamber capable of receiving either liquid or vapor under pressure from the supply reservoir. The hyperbaric process chamber can be capable of releasing vapor under pressure from the process chamber. The hyperbaric process chamber can be capable of releasing liquid under pressure from the process chamber to drain the chamber and begin the vapor dry sequence. A controlled process chamber pressure release can be used to nucleate and expand vapor under pressure so that droplets of liquid remaining on or in the part after chamber has been drained will be rapidly displaced and vaporized.

In an exemplary process, the process chamber is filled with liquid from the reservoir. Pressure is then cycled, for example, released for the formation of bubbles and increased for the termination of bubbles. The liquid can be drained and replaced with new liquid from the reservoir, and the cleaning cycle is repeated. After complete cleaning, the liquid is drained. The process chamber is filled with steam. Pressure can be cycled, for example, released by opening a relief valve and increased by adding new steam from the reservoir. After complete cleaning, the steam is released. The steam cleaning cycles can clean, dry and sterilize the object.

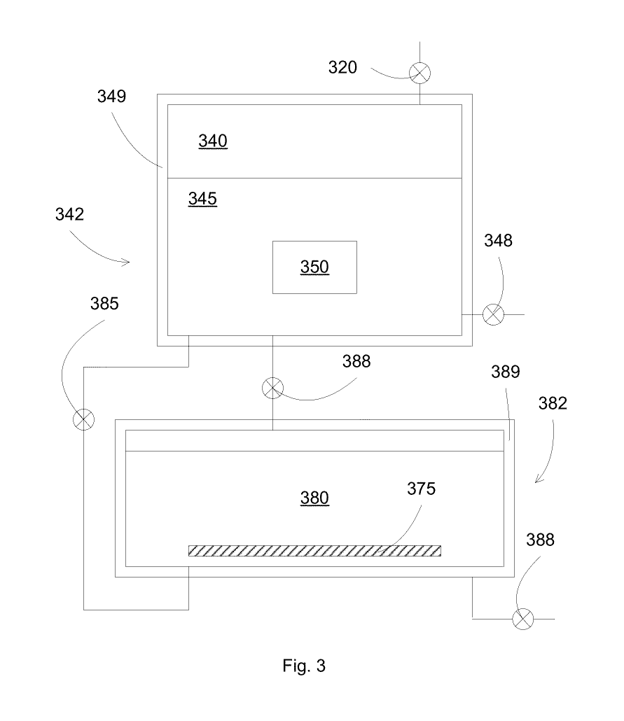

FIG. 3 illustrates a system for operating hyperbaric CNX according to some embodiments. A chamber containing a liquid 545, which is partially filled the chamber with an object 550 submerged in the liquid 545. A relief valve 520 is coupled to the chamber to release the chamber pressure. A heated liquid can be introduced to the chamber, for example, from a reservoir 382. Cyclic nucleation process from a hyperbaric pressure can be performed after introducing the liquid, for example, by cycling the relief valve 520 (e.g., repeating opening and closing). The liquid can be constantly or intermittently added from the reservoir during the cyclic nucleation process. The reservoir can be heated to maintain a constant supply of liquid at the proper pressure, e.g., hyperbaric pressure, to the chamber. The relief valve 320 can perform cyclic nucleation process, cleaning the object 350 by cycling the high pressure to lower values, crossing the boiling curve for generating and terminating bubbles. A drain valve 348 can be included for draining the liquid, for example, when the cleaning process is completed. In addition, valve 388 can be open to deliver the heated vapor to the chamber 342, submerging the object 350 within vapor 340 (preferably after the liquid has been drained). Insulation 349 can be used to maintain the high temperature of the process chamber 342.

A reservoir 382 can supply high energy liquid to chamber 342 through a valve 385, and high energy vapor through a valve 388. Heater 375 can be used to heat the liquid 380 to a pressure above atmospheric pressure. Heater 375 can be constantly heated to maintain the proper temperature and pressure for the liquid 380. Valve 385 can be open to deliver the heated liquid to the chamber 342, submerging the object 350 within liquid 345, leaving vapor portion 340. A drain valve 588 can be included for draining the liquid in the reservoir, for example, when the cleaning process is completed. Insulation 389 can be used to maintain the high temperature of the reservoir 382.

In some embodiments, by maintaining the liquid at high pressure, the liquid can be brought to a higher temperature without any bubble formation. The present invention thus can enable a cyclic process at high temperature, e.g., higher than the boiling temperature of the liquid medium. The high temperature can allow the use of inexpensive liquid, such as water, for cleaning instead of the more expensive solvent or cleaning chemicals. The high temperature can also allow sterilization, since microscopic organisms cannot survive high temperature exposure, such as 130 or 160 degrees.

In addition, the present invention can simplify the cleaning equipment, for example, by eliminating the vacuum pump needed to reduce the pressure to below atmospheric pressure. Instead, a relief valve can be used to reduce pressure from a pressure above the atmospheric pressure.

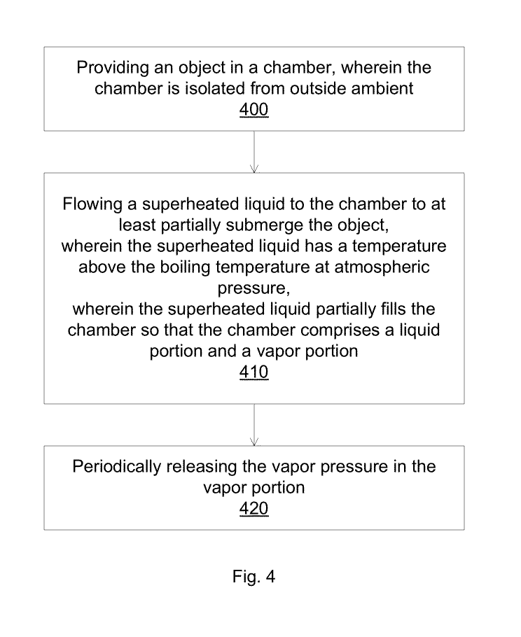

FIG. 4 illustrates a flow chart for a hyperbaric CNX process according to some embodiments. A process chamber can be filled with a superheated liquid from the reservoir. Pressure is then cycled, for example, released for the formation of bubbles and increased for the termination of bubbles. The liquid can be drained and replaced with new liquid from the reservoir, and the cleaning cycle is repeated. After complete cleaning, the liquid can be drained.

In operation 400, an object is provided in a chamber. The chamber can be isolated from outside ambient, for example, by o-ring seals. In operation 410, a liquid can be flowed to the chamber to at least partially submerge the object. The liquid can partially fill the chamber so that the chamber has a liquid portion and a vapor portion. The liquid can have a temperature above the boiling temperature at atmospheric pressure. The liquid can be a superheated liquid. In operation 420, the vapor pressure in the vapor portion of the chamber can be periodically released.

In some embodiments, the vapor pressure can be released at a rate so that bubbles can be generated at a surface of the object. For example, at optimized vapor released, e.g., controlled relief orifice, the vapor can escape from the chamber, reducing the vapor pressure, and bubbles can be generated at the surface of the object. The pressure release can be controlled to minimize fast vapor released, e.g., high relief orifice, since the vapor can quickly escape from the chamber, and bubbles can be generated within the liquid.

In some embodiments, the time for stopping pressure release can be configured to terminate the generated bubbles. For example, after the vapor pressure is released, the liquid can be boiled, increasing the vapor pressure. After a certain time, for example, when the pressure is at equilibrium, the increase in vapor pressure can terminate the bubble generation. The time for stopping pressure release can be configured to permit the pressure built up in the chamber.

In some embodiments, the liquid can include superheated liquid. The superheated liquid can include water at temperature above 100 C., such as between 110 and 200 C. The pressure of the superheated liquid can be between 1 and 20 bars.

In some embodiments, the process can further include draining a portion of the superheated liquid from the chamber. After cyclically releasing vapor pressure from the chamber, the liquid can be cooled down, and the pressure can be approach atmospheric pressure. All or a portion of the liquid in the chamber can be drained, either to a drainage or to a recycle chamber such as a reservoir chamber to be reheated. Additional heated liquid, such as superheated liquid, can be added to the chamber. Alternatively or additionally, additional heated vapor, such as superheated steam, can be added to the chamber.

In some embodiments, the process can further include repeating flowing a superheated liquid and periodically releasing pressure. Also the process can further include repeating flowing a superheated liquid, periodically releasing pressure, and draining the superheated liquid.

In some embodiments, a drying process can be included. For example, the process can further include draining the superheated liquid and/or the superheated vapor from the chamber at a rate to evaporate liquid droplets adhering to the object.

In some embodiments, the present invention discloses systems and processes for hyperbaric clean and dry process. The pressure can cycle between high and low pressure for cyclically cleaning the object with the high energy liquid. The pressure can be quickly released for drying the object, after cleaning is completed.

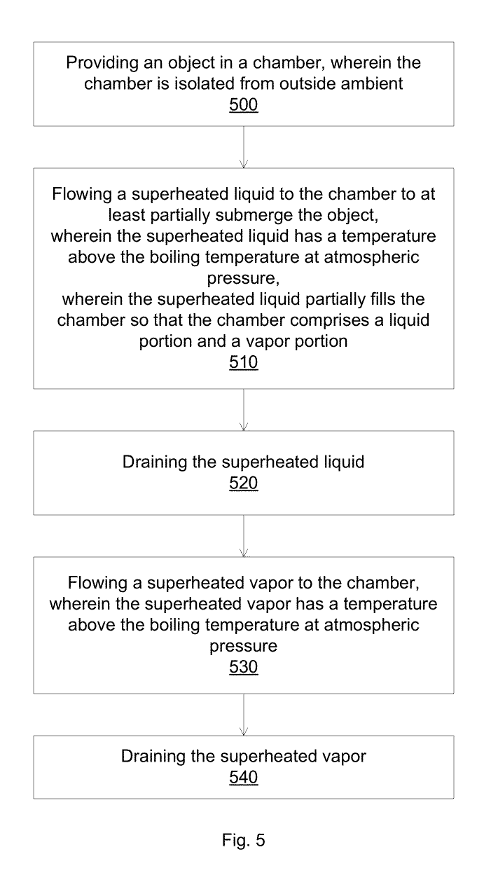

FIG. 5 illustrates a flow chart for a hyperbaric cyclic cleaning and drying process according to some embodiments.

In operation 500, an object is provided in a chamber. The chamber can be isolated from outside ambient, for example, by o-ring seals. In operation 510, a liquid can be flowed to the chamber to at least partially submerge the object. The liquid can partially fill the chamber so that the chamber has a liquid portion and a vapor portion. The liquid can have a temperature above the boiling temperature at atmospheric pressure. The liquid can be a superheated liquid.

In operation 520, the liquid is drained. In operation 530, a vapor, such as a superheated steam, can be flowed to the chamber. The vapor has a temperature above the boiling temperature at atmospheric pressure. In operation 540, the vapor can be drained. The vapor can be drained from the chamber at a rate to evaporate liquid droplets which are adhered to the object.

In some embodiments, the superheated liquid can be used to clean the object, for example, by cycling the vapor pressure within the chamber for generating and terminating the bubbles. Additional superheated liquid and/or vapor can be added to the chamber for further cycling. In some embodiments, the liquid can include superheated liquid. The superheated liquid can include water at temperature above 100 C., such as between 110 and 200 C. The pressure of the superheated liquid can be between 1 and 20 bars.

### Dynamic Cyclic Nucleation Transport (D-CNX)

CNX processes can be preformed using valves and vacuum pumps. This vacuum pump mechanism typically requires 3 to 8 seconds per cycle due to the time required to open and close valves and the limitations in vacuum pump capability. Furthermore, the process of continually pumping vapor and liquid droplets from the chamber tends to cause unwanted evaporative cooling and fluid loss. Now a mechanical CNX mechanism can addresses these problems to reduce the time for each nucleation cycle to fractions of a second rather than seconds. The mechanical CNX can include a mechanism to dynamically change the chamber volume, e.g., enlarging or reducing a chamber volume, thus can generate or collapse a non-liquid space separated from the liquid. The mechanical CNX can include a mechanism to dynamically lower or raising a liquid level in the chamber volume, thus can generate or collapse a non-liquid space separated from the liquid. Since the liquid in the chamber is incompressible, a chamber enlarging process can generate a non-liquid space, e.g., a vacuum space or a vapor or gaseous space to occupy the difference in the chamber volume. The non-liquid space can include a vacuum space, which can also include vapor or gas evaporated or released from the liquid. The process can be similar to forming a vacuum in the chamber through a vacuum pump to generate bubbles. A chamber volume reduction can reduce the non-liquid space, for example, by liquid replacing vacuum, or by reabsorbing the vapor or gas back to the liquid, or by releasing the vapor or gas to the outside ambient. The process can be similar to pressurizing the chamber to terminate the bubbles.

Vacuum CNX technology can be used to grow and collapse vapor bubbles for cleaning and other surface treatment processes. The use of vacuum pumps can limit the cycle time, which is governed by the time constrains imposed by the complex control mechanisms used to cycle chamber pressure up and down. The implementation of a mechanical mechanism directly coupled to the chamber wall, e.g., a piston to dynamically change the chamber volume, can significantly simplify and speed up the nucleation-re-pressurization cycle. This concept is referred to as Dynamic Cyclic Nucleation Transport (D-CNX).

The key attribute of liquids is that they are essentially incompressible, and therefore un-expandable as well. In a process chamber which is completely filled with liquid and where there is no gap or headspace at the top of the chamber filled with a compressible gas such as air, even the smallest expansion in the volume of the process chamber would produce a vacuum gap. This resulting vacuum would of course cause immediate vapor bubble nucleation (CNX process) and vapor bubbles would continue to form and grow until the chamber expansion stopped. Conversely, a contraction in the volume of the process chamber size would cause these vapors to condense and the bubbles would collapse. A simple piston connected to the process chamber could effectively cause chamber volume expansion and contraction.

In some embodiments, the present invention discloses methods and systems for performing CNX, employing a piston actuated mechanism. A piston mechanism can be incorporated to a process chamber to change the volume of the process chamber. For example, bellows seals can be used so that the volume of the process chamber can be reduced during the contraction phase of the bellows, and increased during the expansion phase of the bellows. Alternatively, other type of seals, such as o-ring seals, can be used.

In some embodiments, the piston mechanism can be balanced by air ambient or a liquid medium. A liquid reservoir can be coupled to the other end of the piston, allowing a liquid to liquid seal across the piston, thus prevent air leakage to the process chamber.

A piston system could be connected to the process chamber using a bellows design for absolute vacuum and chamber seal integrity, or a traditional piston and cylinder with ring seals could be incorporated. For example, a bellows system coupled to a chamber wall can be used for a perfect seal. A piston mechanism coupled to a chamber wall can be used with multiple ring seals for vacuum integrity and leak prevention. Alternatively, a piston can be used with process fluid on both sides so that slight leakage in and out of the process chamber is contained in a small process fluid reservoir. Other methods for changing a chamber volume can be used.

In some processes, there will be a reaction between parts and process fluid such that a gas by product is released. This gas byproduct can be beneficial as its expansion during a vacuum cycle will also aid in displacing reaction byproducts and unwanted debris from parts. The overall accumulation of compressible gas however is unwanted in a zero-headspace-liquid-filled process chamber. The accumulated gas will naturally rise to the top of the process chamber where it can be expelled or “burped out” on the recompression cycle through a pressure relief valve at the top of the chamber.

Furthermore, with the concept of a process fluid reservoir available on the backside of the piston, it would be possible to feed fresh fluid into the process chamber upon the backstroke of the piston and then eject both excess process fluid as well as any gas byproduct through the pressure relief valve during the in-stroke of the piston. In this way there will be some process fluid replenishment and an assurance of zero headspace before each backstroke begins.

In some embodiments, methods and systems are disclosed for dynamically changing a chamber volume, to generate and terminate bubbles for cleaning an object. A controlled process chamber pressure release can be used to nucleate and expand vapor and gas bubbles that have been produced or released at the surface of a part in order to displace and expel process fluids, reaction byproducts, and/or unwanted debris and contamination from the surface of the part. The process chamber can be re-pressurized immediately after the pressure release and nucleation step to collapse vapor bubbles and flush the part with fresh process fluid as well as introduce energy from the collapse to enhance surface reactions and displace reaction byproducts and/or unwanted debris and contamination from the surface of the part. A piston actuation can be used to effectively change the volume of the process chamber to cycle between vacuum and re-pressurization. In some embodiments, the piston can be sealed with bellows to provide absolute seal and vacuum integrity. A piston and cylinder can be used with ring seals to provide seal and vacuum integrity. A piston and cylinder can be used with ring seals and backed with process fluid in a reservoir to prevent air leaks into the chamber and provide sufficient vacuum integrity. A pressure relief check valve can be incorporated to the chamber to release the possible buildup of compressible gas byproducts released inside the process chamber. A piston and cylinder can be used with ring seals and backed with process fluid in a reservoir to prevent air leaks into the chamber and provide sufficient vacuum integrity and with a bleed-in feature added to the cylinder such that during the backstroke, process fluid will be drawn into the chamber under vacuum and excess fluid and or by-product gasses will be expelled back to the process fluid reservoir through a pressure relief check valve during the in-stroke.

In some embodiments, a piston can be coupled to a process chamber to change its volume, allowing vacuum formation in the process chamber. The piston can be pushed against sealed air of a slave cylinder, thus preventing leakage of the process chamber. Liquid might leak through the piston seals, and exhaust or vacuum can be incorporated to the slave cylinder for evacuate any leakage liquid. A process reservoir can be used for supplying liquid to the process chamber. In addition, a process fluid reservoir can be coupled to the other end of the piston to minimize liquid leakage. A process reservoir can be used for supplying liquid to the process chamber.

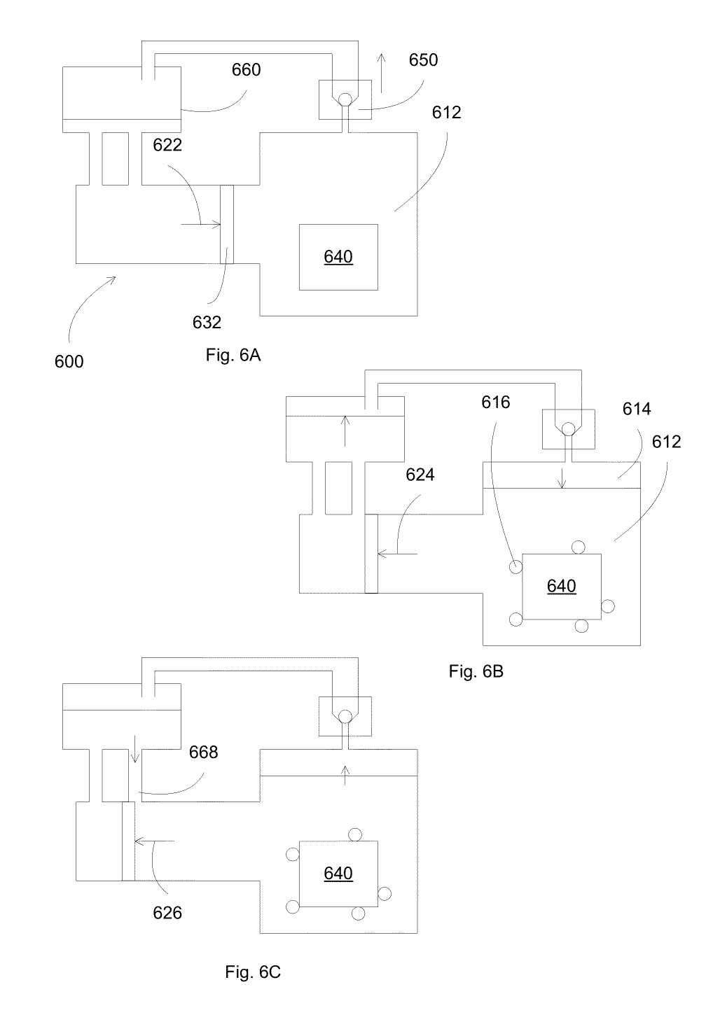

FIGS. 6A-6C illustrate a dynamic chamber using piston according to some embodiments. In FIG. 6A, an object 640 is submerged in a liquid 612 in a chamber 600. The chamber is preferably totally filled with the liquid 612, without any head space of vapor. A relief valve, such as check valve 650, can be connected to a top portion of the container, which can release any gaseous elements in the chamber. A piston 632 is coupled to a chamber wall, which can move under a force to reduce or enlarge the volume of the chamber. As shown, a force 622 is pushing on the piston, pressurizing the liquid, terminating any bubbles. A chamber 660 is coupled to the opposite side of the piston, containing liquid with a head space coupled to the relief valve 650. The liquid can reduce the potential leakage of liquid across the piston, together with replenishing the liquid in the process chamber.

In FIG. 6B, a force 624 is pulling on the piston, enlarging the volume of the process chamber. Vacuum head space 614 appears on top of the liquid portion 612, together with bubbles 616 on the surfaces of the object 640, and also on the chamber surface. The liquid 664 rises in chamber 660.

In FIG. 6C, a force 626 is further pulling on the piston, passing a conduit 668 of the chamber 660, releasing some liquid from chamber 660 to the process chamber. The liquid in the chamber can increase, and thus during the pushing of the piston, excess liquid can return to the chamber 660. As shown, the conduit 688 is coupled to the chamber wall near the piston 632. Other configurations can be used, for example, the conduit 668 can be coupled to any other part of the chamber 600. Since a vacuum 614 is established in the chamber 600, a suction force can be present to pull an external liquid to the chamber. Further, optional components can be coupled to the conduit 668, such as a needle valve to control the flow through the conduit 668, or a check valve can be added to the conduit 668 to prevent back flow. In addition, a heater can be coupled to the conduit 668 to heat the liquid supplying to the chamber 600. Alternatively, a different reservoir can be used to connect to the conduit 668, instead of the reservoir 660.

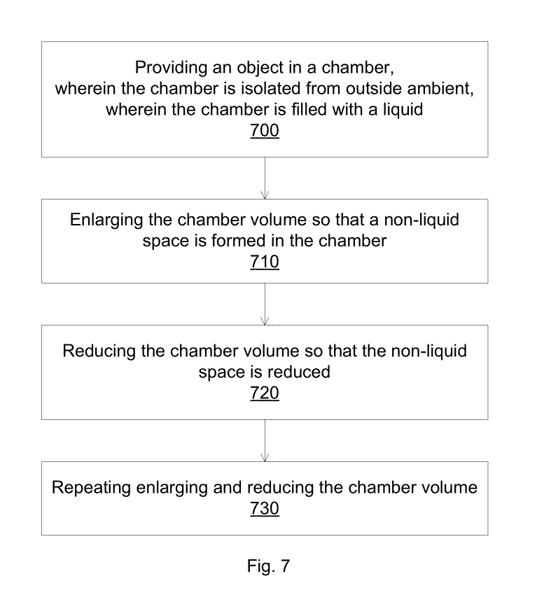

FIG. 7 illustrates a flow chart for a dynamic CNX process according to some embodiments. Operation 700 provides an object in a process chamber. The chamber can be isolated from outside ambient. The chamber can be filled with a liquid. Operation 710 enlarges the volume of the process chamber so that a non-liquid space is formed in the chamber. Bubbles can be formed at a surface of the object when the chamber volume is enlarged. Operation 720 reduces the volume of the process chamber so that the non-liquid space is reduced. Bubbles can be terminated when the chamber volume is reduced. Step 710 and step 720 can be executed in any order, such as enlarging before reducing or reducing before enlarging. Operation 730 repeats the steps of volume enlarging and reducing for nucleation cleaning. Optionally, the liquid can be drained. The object can then be optionally dried, for example, by introducing superheated steam and then venting the steam. The steam can be re-introduced and re-vent for further drying the object.

In some embodiments, the non-liquid space can include a vacuum. The non-liquid space can also include a gaseous or vapor released from the liquid. The liquid can include water, such as deionized water. The liquid can be heated, for example, by an external heater before introduced to the chamber.

In some embodiments, the level of the liquid in the chamber can be lowered or raised by a mechanical mechanism.

In some embodiments, the chamber volume can be enlarged or reduced by a piston. The piston can be coupled to a liquid reservoir for prevent air leakage to the chamber.

In some embodiments, additional liquid or gas can be added to the chamber when the chamber volume is enlarged. The additional liquid can be provided from the reservoir coupled to the piston, or from a separate reservoir. The additional liquid can be heated before entering the chamber. The additional liquid can include a chemical liquid. A controlled flow device can be used to control the flow of the additional liquid to the chamber.

In some embodiments, at least a portion of the non-liquid space is removed from the chamber during the chamber volume reduction. For example, a relief valve or a one-way valve can be used to remove gas or vapor from the chamber during the chamber volume reduction. The chamber volume can be reduced to less than the original volume to remove a large portion of gas or vapor from the chamber.

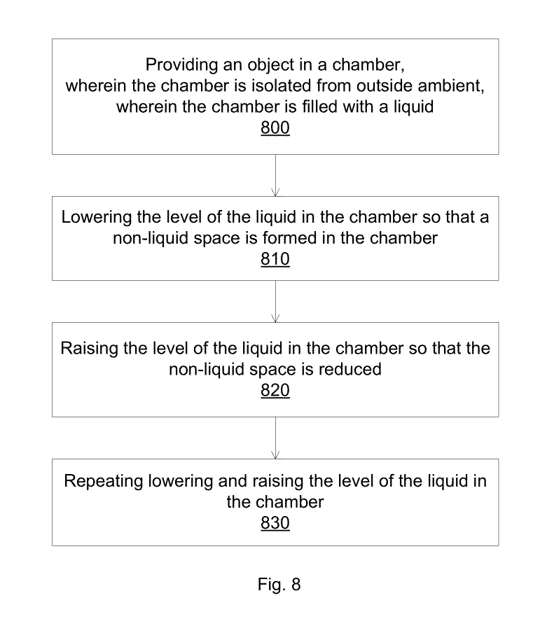

FIG. 8 illustrates a flow chart for a dynamic CNX process according to some embodiments. Operation 800 provides an object in a process chamber. The chamber can be isolated from outside ambient. The chamber can be filled with a liquid. Operation 810 lowers the level of the liquid in the chamber so that a non-liquid space is formed in the chamber. Bubbles can be formed at a surface of the object when the liquid level in the chamber volume is lowered. Operation 820 raises the level of the liquid in the chamber so that the non-liquid space is reduced. Bubbles can be terminated when the liquid level in the chamber volume is raised. Step 810 and step 820 can be executed in any order. Operation 830 repeats the steps of liquid level lowering and raising for nucleation cleaning. Optionally, the liquid can be drained. The object can then be optionally dried, for example, by introducing superheated steam and then venting the steam. The steam can be re-introduced and re-vent for further drying the object.

### Thin Liquid Cyclic Nucleation Transport (Thin Liquid CNX)

The benefit of utilizing CNX technology to grow and collapse vapor bubbles for cleaning and other surface treatment processes is clear. This benefit opens the door to another technology which can also serve as an effective displacement mechanism. This mechanism will use gas rather than vapor to serve as a displacement medium. The primary difference between a vapor and a gas is condensability—a vapor bubble will collapse and be converted to an incompressible liquid once its vapor pressure is exceeded, but a gas bubble will generally not disappear unless it can be dissolved into the liquid (which is a much slower process). This key difference can be taken advantage of to create significant displacement volumes and forces inside complex parts.

Generally a gas will expand according to the Ideal Gas Law equation, PV=nRT. Since the product nRT can be assumed to be constant, the volume of the gas “V” will vary inversely to the pressure “P”. If a gas is trapped or collected inside a part and it has a volume of “x” at atmospheric pressure, that same gas will have a volume of “10x” when the pressure drops to 1/10th atmosphere. Expansion ratios much higher than this can be achieved by the use of simple hyperbaric chambers. The above description is provided for illustrative purpose, and is not meant to limit the validity of the invention, which is defined by the claims.

There are several likely sources of non-vapor gasses which can be found inside parts. For example, a gas can be provided as a gas by-product from chemical reactions. This can be a byproduct of the process fluid with materials in or on the surface of parts, e.g., fluid-part chemical reaction, or it could be a result of gasses produced as a reaction between chemicals found in the solution, e.g., fluid-fluid chemical reaction. Further, a gas can be provided as dissolved gas stored in the process fluid which gets released when subjected to agitation, a drop in pressure, a chemical reaction, or a combination of these mechanisms.

If the quantity of trapped gas inside the part can be expanded to a volume that exceeds the internal volume of the part, then complete displacement can be achieved. Once the gas is removed under vacuum, a re-pressurization allows fresh process fluid back in to the part and the process can be repeated.

A controlled chamber pressure can be used to expand gasses that have been produced or released and trapped or accumulated inside a part in order to displace and expel process fluids, reaction byproducts, and/or unwanted debris and contamination that would otherwise be trapped inside the part. The chamber can be pressurized immediately after the pump down and expulsion step to flush the part with fresh process fluid. A process fluid chemistry can be used to produce or release gas once it is introduced into the part by means of a reaction between the process fluid and material on or at the surface of the part being processed. A process fluid chemistry can be used to produce or release gas once it is introduced into the part by means of a reaction between different chemicals in the process fluid. A process fluid chemistry can be used to produce or release gas once it is introduced into the part by releasing gasses that have been dissolved in the process fluid chemistry. A rotational mechanism can be included to constantly change the orientation of complex parts so the trapped gasses accumulate in different areas of the part and expel process fluids, reaction byproducts, and/or unwanted debris and contamination that would otherwise be trapped inside the part.

In CNX process, a net volumetric vapor outflow can be generated from the surface of the object to the outside ambient or to the vapor head space above the liquid level. This vapor outflow can be the result of bubbles leaving the object surfaces or exiting trapped spaces in the object.

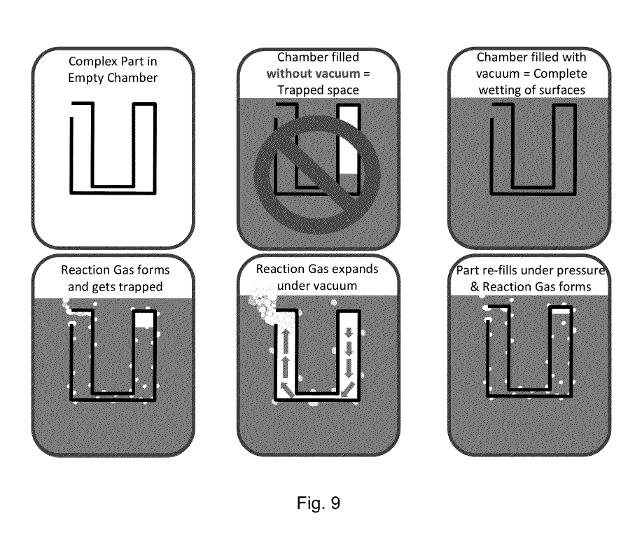

FIG. 9 illustrates a process sequence for an effective displacement according to some embodiments. Without vacuum head space, the gas can be trapped inside the object. With additional gaseous species released to the liquid, the trapped gas can be removed and the cavity inside the object can be filled with liquid for cleaning

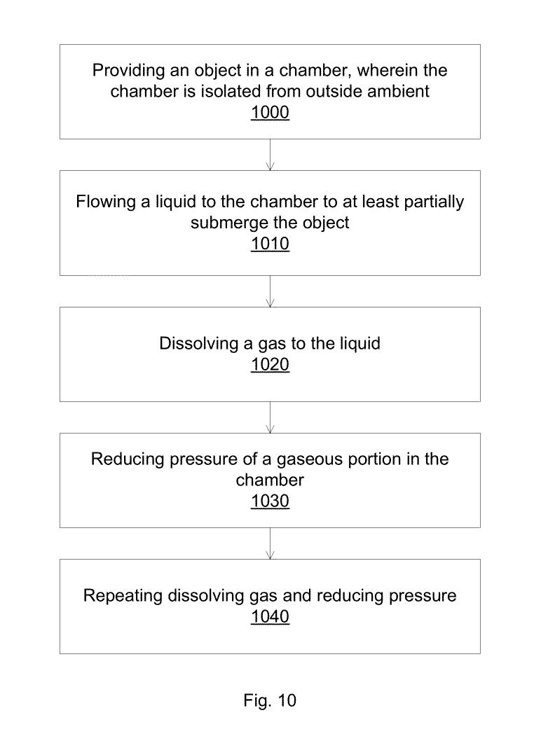

FIG. 10 illustrates a flowchart example for a CNX process according to some embodiments. In operation 1000, an object is provided in a chamber. The chamber can be isolated from outside ambient. In operation 1010, a liquid can be flowed to the chamber to at least partially submerge the object. In operation 1020, a gas is dissolved to the liquid. In operation 1030, the pressure of a gaseous portion in the chamber is reduced. In operation 1040, dissolving gas and reducing pressure processes are repeated.

In some embodiments, the process can be used with hyperbaric CNX, e.g., using high pressure liquid for cycling bubbles, or with dynamic CNX, e.g., using chamber volume changes to generate and terminate bubbles.

In some embodiments, the liquid can include water, such as deionized water. The liquid can partially fill the chamber so that the chamber has a liquid portion and the gaseous portion.

In some embodiments, the pressure can be reduced by enlarging the chamber volume, by pumping the gaseous portion, or by lowering the level of the liquid in the chamber. The pressure can be reduced as to form bubbles at a surface of the object. The gas can be added or dissolved to the liquid as to terminate the bubbles.

In some embodiments, a gas can be flowed to the liquid or the gas portion in the chamber to provide the dissolved gas.

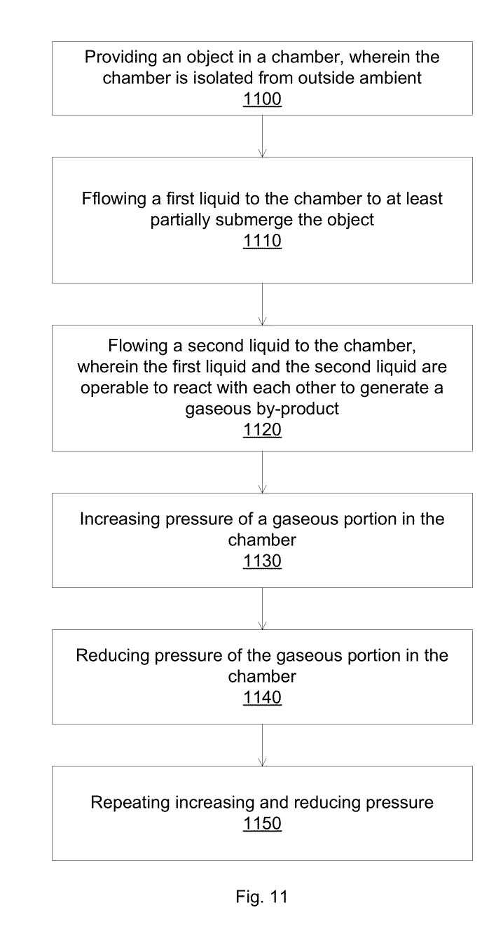

FIG. 11 illustrates a flowchart example for a CNX process according to some embodiments. In operation 1100, an object is provided in a chamber. The chamber can be isolated from outside ambient. In operation 1110, a first liquid can be flowed to the chamber to at least partially submerge the object. In operation 1120, a second liquid can be flowed to the chamber. The first liquid and the second liquid can be operable to react with each other to generate a gaseous by-product. In operation 1130, the pressure in the chamber is increased. In operation 1140, the pressure in the chamber is reduced. In operation 1150, increasing and reducing pressure processes are repeated.

In some embodiments, the process can be used with hyperbaric CNX, e.g., using high pressure liquid for cycling bubbles, or with dynamic CNX, e.g., using chamber volume changes to generate and terminate bubbles.

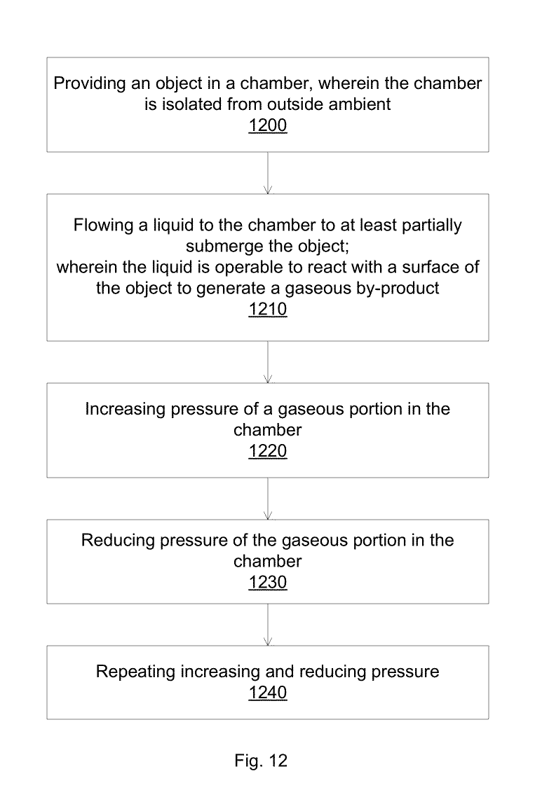

FIG. 12 illustrates a flowchart example for a CNX process according to some embodiments. In operation 1200, an object is provided in a chamber. The chamber can be isolated from outside ambient. In operation 1210, a liquid can be flowed to the chamber to at least partially submerge the object. The liquid can be operable to react with a surface of the object to generate a gaseous by-product. In operation 1220, the pressure in the chamber is increased. In operation 1230, the pressure in the chamber is reduced. In operation 1240, increasing and reducing pressure processes are repeated.

In some embodiments, the process can be used with hyperbaric CNX, e.g., using high pressure liquid for cycling bubbles, or with dynamic CNX, e.g., using chamber volume changes to generate and terminate bubbles.

What is claimed is:

1. A method comprising
providing an object in a chamber, wherein the chamber is isolated from outside ambient;
flowing a liquid to the chamber to at least partially submerge the object;
dissolving a gas to the liquid;
reducing pressure of a gaseous portion in the chamber;
repeating dissolving gas and reducing pressure.

2. A method as in claim 1 wherein the liquid comprises water.

3. A method as in claim 1 wherein the liquid partially fills the chamber so that the chamber comprises a liquid portion and the gaseous portion.

4. A method as in claim 1 wherein reducing pressure is performed by enlarging the chamber volume.

5. A method as in claim 1 wherein reducing pressure is performed by pumping the gaseous portion.

6. A method as in claim 1 wherein reducing pressure is performed by lowering the level of the liquid in the chamber.

7. A method as in claim 1 wherein the pressure is reduced as to form bubbles at a surface of the object.

8. A method as in claim 2 wherein dissolving a gas to the liquid as to terminate the bubbles.

9. A method as in claim 1 wherein dissolving a gas to the liquid comprises flowing a gas to the liquid in the chamber.

10. A method as in claim 1 wherein dissolving a gas to the liquid comprises flowing a gas to the gaseous portion.

11. A method comprising
providing an object in a chamber, wherein the chamber is isolated from outside ambient;
flowing a first liquid to the chamber to at least partially submerge the object;
flowing a second liquid to the chamber,
wherein the first liquid and the second liquid are operable to react with each other to generate a gaseous by-product;
increasing pressure of a gaseous portion in the chamber;
reducing pressure of the gaseous portion in the chamber;
repeating increasing and reducing pressure.

12. A method as in claim 11
wherein increasing pressure is performed by reducing the chamber volume,
wherein increasing pressure is performed by flowing a gas to the chamber, or
wherein increasing pressure is performed by raising the level of the liquid in the chamber.

13. A method as in claim 11
wherein reducing pressure is performed by enlarging the chamber volume,
wherein reducing pressure is performed by pumping the gaseous portion, or
wherein reducing pressure is performed by lowering the level of the liquid in the chamber.

14. A method as in claim 11 wherein pressure is reduced as to form bubbles at a surface of the object.

15. A method as in claim 14 wherein pressure is increased as to terminate the bubbles.

16. A method comprising
providing an object in a chamber, wherein the chamber is isolated from outside ambient;
flowing a liquid to the chamber to at least partially submerge the object;
wherein the liquid is operable to react with a surface of the object to generate a gaseous by-product;
increasing pressure of a gaseous portion in the chamber;
reducing pressure of the gaseous portion in the chamber;
repeating increasing and reducing pressure.

17. A method as in claim 16
wherein increasing pressure is performed by reducing the chamber volume,
wherein increasing pressure is performed by flowing a gas to the chamber, or
wherein increasing pressure is performed by raising the level of the liquid in the chamber.

18. A method as in claim 16
wherein reducing pressure is performed by enlarging the chamber volume,
wherein reducing pressure is performed by pumping the gaseous portion, or
wherein reducing pressure is performed by lowering the level of the liquid in the chamber.

19. A method as in claim 16 wherein pressure is reduced as to form bubbles at a surface of the object.

20. A method as in claim 19 wherein pressure is increased as to terminate the bubbles.
